(19) United States
(12) Patent Application Publication
(10) Pub. No.: US 2006/0121184 A1
(43) Pub. Date: Jun. 8, 2006

(54) Photocurable-resin application method and bonding method

(76) Inventors: Masanori Minamio, Osaka (JP); Tetsushi Nishio, Kyoto (JP); Toshiyuki Fukuda, Kyoto (JP)

Correspondence Address: MCDERMOTT WILL & EMERY LLP, 600 13TH STREET, N.W., WASHINGTON, DC, 20005-3096, US

(21) Appl. No.: 11/269,748

(22) Filed: Nov. 9, 2005

(30) Foreign Application Priority Data
Dec. 6, 2004 (JP) 2004-352899

(51) Int. Cl. B05D 5/06

(52) U.S. Cl. 427/162

(57) ABSTRACT

An adhesive sheet is attached to a package substrate having a through hole so that an ultraviolet (UV) curable resin layer of the adhesive sheet faces the package substrate. Light is then radiated to the UV curable resin layer through the through hole in order to cure the exposed part of the UV curable resin layer. The cured part of the UV curable resin layer is removed together with a base film of the adhesive sheet. A glass plate is then attached to the UV curable resin remaining on the package substrate. Light is then radiated to bond the glass plate to the package substrate.

### CROSS REFERENCE TO RELATED APPLICATIONS

This application claims priority under 35 U.S.C. §119 on Patent Application No. 2004-352899 filed in Japan on Dec. 6, 2004, the entire contents of which are hereby incorporated by reference.

### BACKGROUND OF THE INVENTION

1. Technical Field

The present invention generally relates to a photocurable-resin application method and a bonding method. More particularly, the present invention relates to a photocurable-resin application method using a sheet that is made of a lamination of a base film and a photocurable resin layer, and a bonding method using the application method.

2. Background Art

A semiconductor chip having a solid-state image sensing element as a kind of optical element such as CCD (Charge Coupled Device) is packaged as shown in FIG. 9. Such a packaged semiconductor chip is commercially available as a solid-state image sensing device such as a CCD area sensor and a CCD line sensor. For example, in a solid-state image sensing device disclosed in Japanese Patent Laid-Open Publication No. 2002-329852, a package 200 has a stepped surface so that a storage section 204 for storing a semiconductor chip 202 is formed in the center of the surface. The semiconductor chip 202 is fixed to the surface of the storage section 204. Terminals of the package 200 are provided in a stepped portion 208 of the package 200. Terminals of the semiconductor chip 202 are electrically connected to the terminals of the package 200 by bonding wires 206, respectively. A cover glass 210 is fixed to the top of the package 200 by an adhesive. Nitrogen gas is introduced into the internal space surrounded by the package 200 and the cover glass 210, and the semiconductor chip 202 is hermetically sealed. Pins 212 for connecting with signal lines are provided on the back surface of the package 200.

In this solid-state image sensing device, the semiconductor chip 202 is connected to external terminals by wire bonding. Therefore, this solid-state image sensing device requires a large package size, and also requires higher costs due to wire bonding. In order to solve these problems, a chip size package (CSP) which connects a semiconductor chip to a wiring substrate by solder balls or the like has been used for solid-state image sensing devices.

FIG. 10 shows a solid-state image sensing device disclosed in Japanese Patent Laid-Open Publication No. 2002-329852. This solid-state image sensing device is a small device using a CSP. A spacer 160 is provided on the surface of a semiconductor chip 152 so as to surround a region 170 where microlenses 150 are provided. The spacer 160 separates the region 170 from a region 172 surrounding the region 170. In the region 172, a plurality of electrode pads 158 having an approximately rectangular shape are arranged at prescribed intervals along the opposing shorter sides of the semiconductor chip 152. Each electrode pad 158 is electrically connected to a corresponding electrode of a solid-state image sensing element formed on the semiconductor chip 152.

An end of each electrode pad 158 is electrically connected to a corresponding lead wire 182 that extends down across the side surface of the semiconductor chip 152 to the back surface of a substrate 156. A transparent glass substrate 164 is placed so as to face the region 170 of the semiconductor chip 152. The spacer 160 is interposed between the semiconductor chip 152 and the transparent substrate 164. The spacer 160 separates the semiconductor chip 152 from the transparent substrate 164 by a fixed distance so that the transparent substrate 164 does not contact the microlenses 150. The surfaces of the microlenses 150 are thus prevented from being damaged by contact with the transparent substrate 164.

In the region 172 of the semiconductor chip 152, the semiconductor chip 152 is attached to the transparent substrate 164 by an adhesive 162. As a result, the transparent substrate 164 is fixed to the semiconductor chip 152, and a small space 166 formed between the semiconductor chip 152 and the transparent substrate 164 is sealed. An example of the adhesive 162 is an ultraviolet (UV) curable resin such as photosensitive polyimide.

As described in Japanese Patent Laid-Open Publication No. 2004-64415, the adhesive 162 is commonly applied with a dispenser so that the application amount is accurately adjusted.

When the adhesive is applied with a dispenser, the application amount can be accurately adjusted, but the adhesive cannot always be accurately applied only to an application target region (a region to which the adhesive is intended to be applied). Therefore, the adhesive may be applied also to a region other than the application target region, or may be applied to a region smaller than intended, causing defective bonding. The adhesive that is applied to a region of the semiconductor chip other than the application target region adversely affects the image (for example, the image always has a shadow). The adhesive that is applied to a region outside the semiconductor chip other than the application target region adversely affects the accuracy of the outer shape of the package. The solid-state image sensing device having such a defective image is a defective product. The package having an inaccurate outer shape can cause misalignment of the solid-state image sensing device when the solid-state image sensing device is mounted on a wiring substrate or incorporated into other apparatuses. Such misalignment can cause defective conduction. Moreover, when such misalignment occurs, the solid-state image sensing device cannot be firmly fixed, and therefore, can come out of the mounted or incorporated position due to vibration or the like.

### SUMMARY OF THE INVENTION

The present invention is made in view of the above problems, and it is an object of the present invention to provide a photocurable-resin application method that is capable of easily controlling an application position, and a bonding method using the application method.

According to a first aspect of the present invention, a method for applying a photocurable resin includes the steps of: (A) attaching a sheet that is formed from a lamination of a base film and a photocurable resin layer to an application target member so that the photocurable resin layer contacts the application target member; (B) curing a part of the photocurable resin layer by radiating light to the part of the photocurable resin layer; and removing the cured part of the photocurable resin layer together with the base film from the application target member.

In a preferred embodiment, the application target member has a through hole, and in the step (B), the part of the photocurable resin layer is cured by light passing through the through hole.

In a preferred embodiment, the base film has a light-transmitting property, and in the step (B), a light-shielding mask is formed on a part of the base film and the light is radiated to the part of the photocurable resin layer through the base film. The light-transmitting property herein refers to the capability of transmitting at least 50% of light having a wavelength that cures the photocurable resin. In order to reduce the curing time, the base film is preferably capable of transmitting at least 70% of the light, and more preferably, at least 80% of the light.

Preferably, a plurality of application target members are provided, and in the step (A), at least one sheet is attached to the plurality of application target members. Providing the plurality of application target members includes the case where a plurality of members are connected together so that they look like a single application target member.

Preferably, the photocurable resin is an ultraviolet (UV) curable resin.

In a method for bonding a light-transmitting plate to a wiring substrate according to a second aspect of the present invention, the wiring substrate has a through hole, and the light-transmitting plate is bonded to the wiring substrate so as to cover the through hole. The method includes the steps of: applying a photocurable resin to the wiring substrate, an application target member, by using the above method for applying a photocurable resin;

and bonding the light-transmitting plate to the wiring substrate by using the applied photocurable resin.

In a method for bonding a light-transmitting plate to a wiring substrate according to a third aspect of the present invention, the wiring substrate has an optical element chip mounted thereon, the optical element chip has an optical element formed on one surface, and the light-transmitting plate is bonded to the wiring substrate so as to face the surface on which the optical element is formed. The method includes the steps of: applying a photocurable resin to the wiring substrate, an application target member, by using the above method for applying a photocurable resin; and bonding the light-transmitting plate to the wiring substrate by using the applied photocurable resin.

In a preferred embodiment, a spacer portion is provided on the wring substrate in order to prevent the optical element from contacting the light-transmitting plate, and the light-transmitting plate is bonded to the spacer portion.

In a method for bonding a light-transmitting plate to a wiring substrate according to a fourth aspect of the present invention, the wiring substrate has an optical element chip mounted thereon, the optical element chip has an optical element formed on one surface, and the light-transmitting plate is bonded to the wiring substrate so as to face the surface on which the optical element is formed. The method includes the steps of: applying a photocurable resin to the light-transmitting plate, an application target member, by using the above method for applying a photocurable resin; and bonding the light-transmitting plate to the wiring substrate by using the applied photocurable resin.

In a method for bonding a light-transmitting plate to an optical element chip according to a fifth aspect of the present invention, the optical element chip has an optical element formed on one surface, and the light-transmitting plate is bonded to the optical element chip so as to face the surface on which the optical element is formed. The method includes the steps of: applying a photocurable resin to the light-transmitting plate, an application target member, by using the above method for applying a photocurable resin; and bonding the light-transmitting plate to the optical element chip by using the applied photocurable resin.

In a preferred embodiment, a spacer portion is provided on the light-transmitting plate in order to prevent the optical element from contacting the light-transmitting plate, and the photocurable resin is applied to the spacer portion.

### BRIEF DESCRIPTION OF THE DRAWINGS

FIGS. 1A, 1B, 1C, 1D, 1E, and 1F are schematic cross-sectional views showing an application step and a bonding step according to a first embodiment of the present invention;

FIG. 2 is a plan view of a package substrate that is an application target member (a member to which a photocurable resin is intended to be applied) according to the first embodiment of the present invention;

FIG. 3 is a schematic cross-sectional view of a solid-state image sensing device having a glass plate bonded thereto according to the first embodiment of the present invention;

FIGS. 4A, 4B, 4C, and 4D are schematic cross-sectional views showing an application step and a bonding step according to a second embodiment of the present invention;

FIGS. 5A, 5B, 5C, and 5D are schematic cross-sectional views showing an application step and a bonding step according to a third embodiment of the present invention;

FIGS. 6A, 6B, 6C, and 6D are schematic cross-sectional views showing an application step and a bonding step according to a fourth embodiment of the present invention;

FIGS. 7A, 7B, 7C, and 7D are schematic cross-sectional views showing an application step and a bonding step according to a fifth embodiment of the present invention;

FIGS. 8A, 8B, 8C, and 8D are schematic cross-sectional views showing an application step and a bonding step according to a sixth embodiment of the present invention;

FIG. 9 is a cross-sectional view of a package substrate of a conventional example; and

FIG. 10 is a cross-sectional view of a package substrate of a conventional example.

### DETAILED DESCRIPTION OF THE INVENTION

Hereinafter, embodiments of the present invention will be described in detail with reference to the accompanying drawings. The following embodiments are exemplary only, and the present invention is not limited to these embodiments. Note that, in the following embodiments, members having substantially the same function are denoted with the same reference numerals and characters.

### First Embodiment

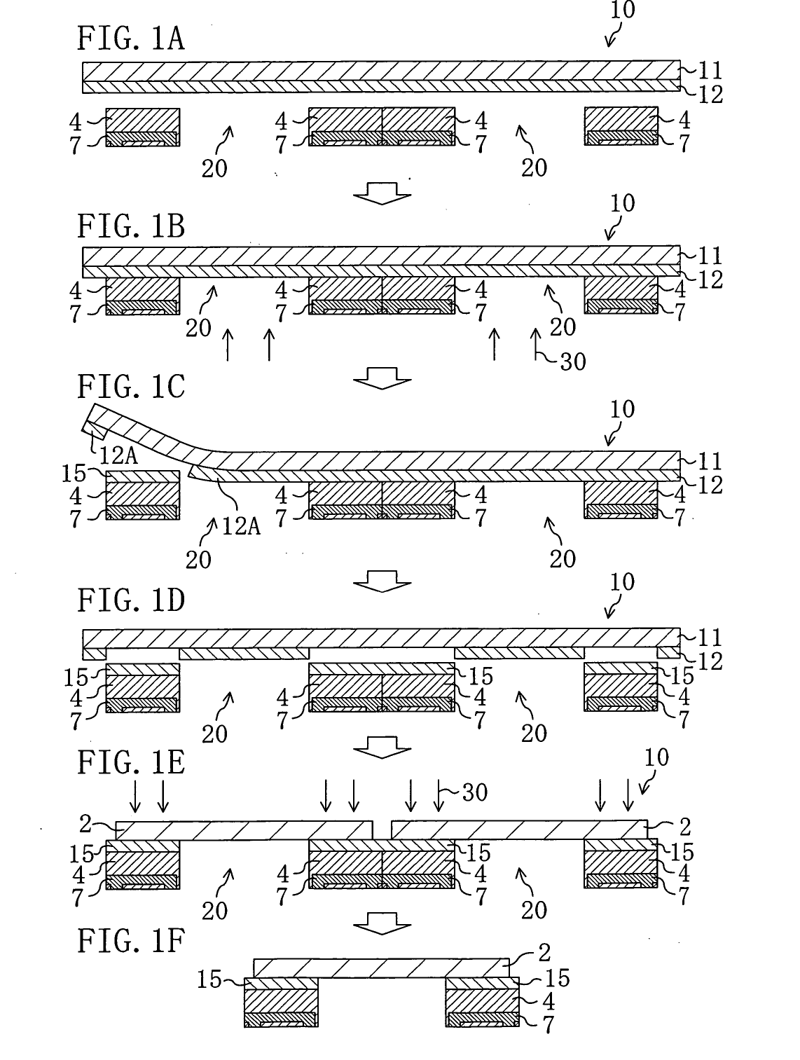

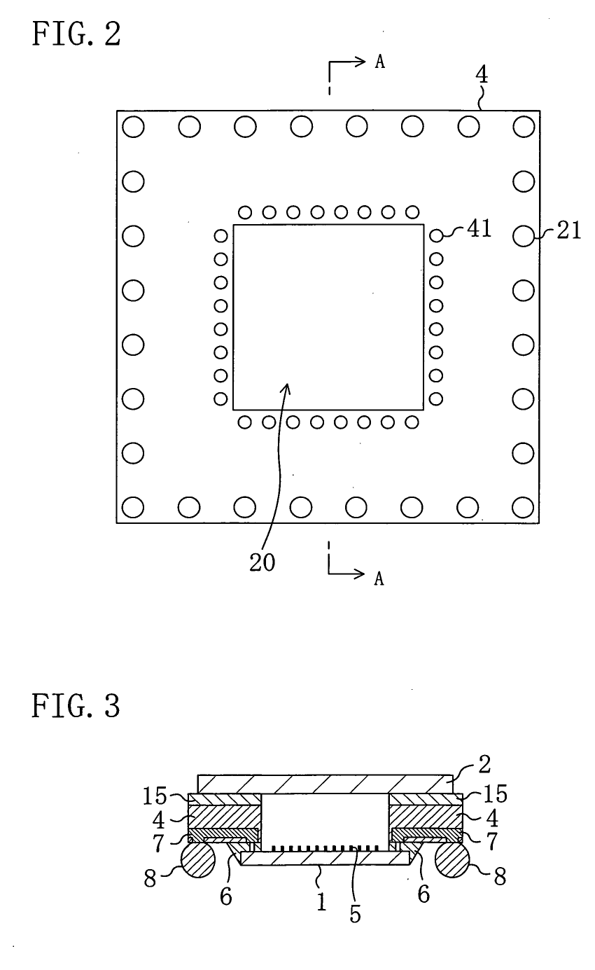

In the first embodiment, a glass plate is bonded to a package substrate (wiring substrate) by applying an ultraviolet (UV) curable resin, a photocurable resin, to the package substrate, and a semiconductor chip (optical element chip) having a solid-state image sensing element formed on its surface is mounted to the resultant package substrate. FIGS. 1A to 1F sequentially illustrate the step of applying an UV curable resin 15 and the step of bonding a glass plate 2. The package substrate is shown in FIG. 2. In FIGS. 1A to 1F, two package substrates 4 connected together are shown in cross section taken along line A-A in FIG. 2.

The package substrate 4 of the present embodiment has an approximately rectangular shape and has a through hole 20 in the center. As described later, a semiconductor chip is mounted so as to cover (close or cap) the through hole 20, and an element connecting portion 41 of the package substrate 4 is connected to connection terminals of the semiconductor chip. The package substrate 4 has an input/output (I/O) connecting portion 21 in its outer periphery. The I/O connecting portion 21 is electrically connected to a printed board to which the package substrate 4 is mounted. In the element connecting portion 41 and the I/O connecting portion 21, a conductive member 7 embedded in the package substrate 4 is exposed to the surface. The package substrate 4 is electrically connected to the power supply and other electronic devices by electrically connecting the package substrate 4 to the printed board. The package substrate 4 does not have a connecting portion on the surface opposite to the surface shown in FIG. 2. This surface (the surface having no connecting portion) is covered with an insulating material.

Hereinafter, a method for applying the UV curable resin 15 and a method for bonding the glass plate 2 by using the UV curable resin 15 will be described.

First, as shown in FIG. 1A, an adhesive sheet 10 is attached to the package substrate 4 (the attaching step A). In the present embodiment, two package substrates 4 are connected together at their outer peripheries, and the adhesive sheet 10 is attached to the surface of the package substrates 4 which is opposite to the surface where the element connecting portion 41 and the I/O connecting portion 21 are exposed. The adhesive sheet 10 is a lamination of a base film 11 and an UV curable resin layer 12. The adhesive sheet 10 is attached so that the UV curable resin layer 12 contacts the package substrates 4.

As shown in FIG. 1B, light 30 containing ultraviolet (UV) rays is radiated from the side of the surface of the package substrate 4 where the element connecting portion 41 and the I/O connecting portion 21 are exposed (the curing step B). The portion of the UV curable resin layer 12 which is exposed by the through holes 20 is cured because the UV rays (light 30) impinge on this portion through the through holes 20. On the other hand, the portion of the UV curable resin layer 12 which is attached to the package substrates 4 is not cured because the light 30 is shielded by the package substrates 4. The portion of the UV curable resin layer 12 which is located outside the outer periphery of the package substrates 4 is also cured by the light 30.

After the exposed portion of the UV curable resin layer 12 is cured, the adhesive sheet 10 is removed from the package substrates 4 as shown in FIG. 1C. The UV curable resin layer 12A that was cured in the curing step B adheres to the base film 11. Therefore, as the adhesive sheet 10 is removed from the package substrates 4, the cured UV curable resin layer 12A is removed together with the base film 11 from the package substrates 4. More specifically, as shown in FIG. 1D, the cured UV curable resin layer 12A is removed together with the base film 11 from the package substrates 4, and the uncured UV curable resin 15 remains on the surface of the package substrates 4. The UV curable resin 15 is thus applied to the whole surface of the package substrates 4 which is opposite to the surface where the element connecting portion 41 and the I/O connecting portion 21 are exposed. The UV curable resin 15 is present neither inside the inner periphery of the through holes 20 nor outside the outer periphery of the package substrates 4.

As shown in FIG. 1E, the glass plate 2, a cover glass, is placed on each package substrate 4 so as to entirely cover the through hole 20. More specifically, the glass plate 2 is placed on the surface of the package substrate 4 which is opposite to the surface where the element connecting portion 41 and the I/O connecting portion 21 are exposed. The UV curable resin 15 is therefore interposed between the glass plate 2 and the package substrate 4. Light 30 containing UV rays is radiated to the UV curable resin 15 from the side of the glass plate 2 in order to cure the UV curable resin 15. The UV curable resin 15 serves as an adhesive and bonds the glass plate 2 to the package substrate 4. Application of the UV curable resin 15 and bonding of the glass plate 2 are thus completed. Thereafter, the two package substrates 4 connected together are separated from each other as shown in FIG. 1F.

As shown in FIG. 3, a semiconductor chip 1 having a solid-state image sensing element 5 formed on its surface is mounted to the package substrate 4 having the glass plate 2 which is produced by the present embodiment. The element connecting portion 41 of the package substrate 4 is connected to terminals of the semiconductor chip 1, and the connected portion is sealed with a resin 6 for protection. Note that this sealing with the resin 6 functions to prevent dust and the like from entering the space between the semiconductor chip 1 and the glass plate 2 and to prevent light as disturbance from entering through the connected portion. Solder balls 8 are connected to the I/O connecting portion 21 of the package substrate 4.

The solid-state image sensing device with the cover glass thus produced is shown in FIG. 3. As described above, in the solid-state image sensing device of FIG. 3, the UV curable resin 15 is present neither inside the inner periphery of the through hole 20 nor outside the outer periphery of the package substrate 4. Therefore, this solid-state image sensing device has no adverse effect on the image and on the accuracy of the outer shape. If the UV curable resin 15 is present inside the inner periphery of the through hole 20, light that is supposed to reach the solid-state image sensing element 5 through the glass plate 2 may be partially shielded by the UV curable resin 15. In this case, a part of the light does not reach the solid-state image sensing element 5. However, the solid-state image sensing device produced by the present embodiment does not have such a problem. If the UV curable resin 15 is present outside the outer periphery of the package substrate 4, misalignment may occur when the solid-state image sensing device is mounted to a wiring substrate, when a lens is mounted to the solid-state image sensing device, and the like. However, the solid-state image sensing device produced by the present embodiment does not have such a problem.

As described above, in the present embodiment, the adhesive sheet 10 is attached to an application target member (a member to which the UV curable resin is intended to be applied), i.e., the package substrate 4 (step A). A part of the UV curable resin layer 12 of the adhesive sheet 10 is then cured by radiating light thereto (step B). Thereafter, the cured UV curable resin layer 12A is removed together with the base film 11 from the package substrate 4. Since the light radiation region can be accurately controlled in the step B, the UV curable resin 15 can be accurately applied to a desired application target region.

The base film 11 of the present embodiment is preferably a plastic film such as a polyester film and a polypropylene film.

The photocurable-resin application method and the bonding method of the present embodiment have the following effects: the UV curable resin, a photocurable resin, can be prevented from being present within the through hole or outside the package substrate. Moreover, this can be easily prevented by merely attaching the adhesive sheet to the package substrate and radiating light to the package substrate. The UV curable resin can be applied only to a required part of the application target member (the package substrate). When a UV curable resin is used as a photocurable resin, an adhesive sheet having desired properties can be obtained at low cost, and curing facilities can be easily obtained and operated at low cost. By using the through hole to cure the UV curable resin as in the present embodiment, an unnecessary part of the UV curable resin can be easily cured without using a light-shielding mask. As a result, the production speed can be increased and the costs can be suppressed. Moreover, since a single adhesive sheet is used for two package substrates, the UV curable resin can be applied to two package substrates at a time. Therefore, the UV curable resin can be applied to many package substrates within a short time. Although the UV curable resin is applied to two package substrates at a time in the present embodiment, the UV curable resin may be applied to three or more package substrates at a time by using one or more adhesive sheets.

### Second Embodiment

In the second embodiment, a photocurable-resin application method for bonding a glass plate to a package substrate (wiring substrate) having a semiconductor chip mounted thereon will be described. Note that the package substrate of the present embodiment has a recess for storing a semiconductor chip having a solid-state image sensing element formed on its surface.

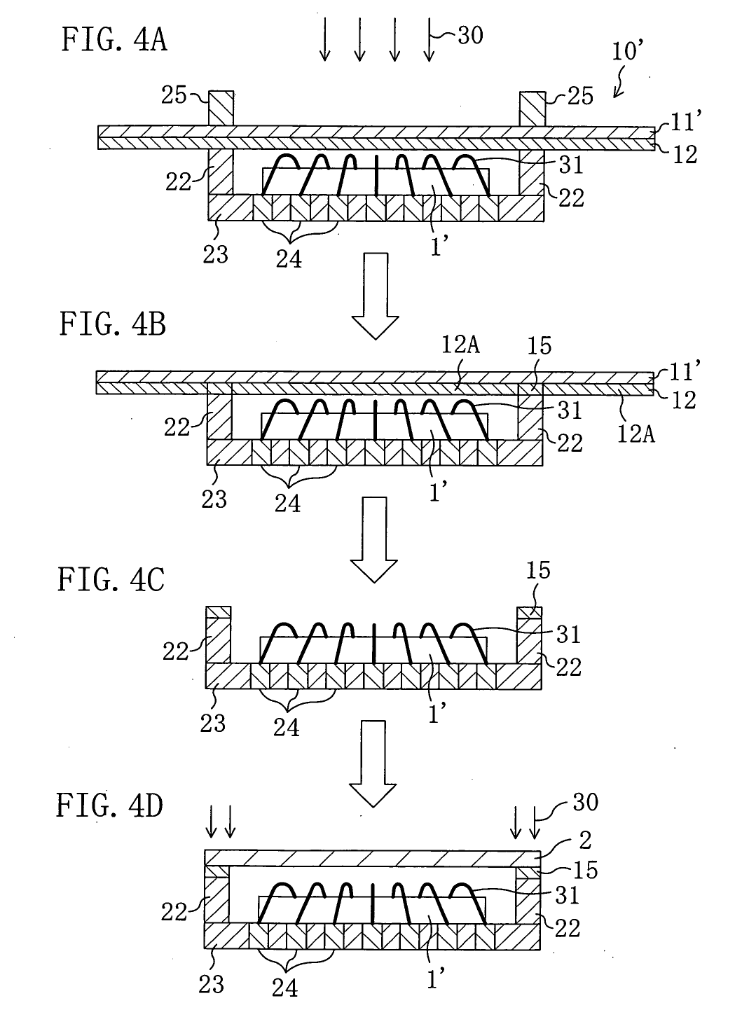

FIGS. 4A to 4D are cross-sectional views illustrating a method for applying a photocurable resin and a method for bonding a glass plate, a light-transmitting plate, according to the present embodiment.

A package substrate 23 of the present embodiment has an approximately rectangular shape, and a sidewall portion 22 is provided on the outer peripheral portion of the package substrate 23. The space inside the sidewall portion 22 is a recess in which a semiconductor chip 1′ is to be mounted. In other words, the sidewall portion 22 is the sidewall of the recess. The semiconductor chip 1′ is fixed to the top surface of the bottom plate of the recess of the package substrate 23. A solid-state image sensing element and input/output (I/O) terminals are formed on the surface of the semiconductor chip 1′ which is opposite to the surface that is fixed to the package substrate 23. Connection vias 24 are embedded in a member that forms the bottom of the package substrate 23, and the I/O terminals are connected to the connection vias 24 by bonding wires 31, respectively. The connection vias 24 are exposed also to the back surface of the member that forms the bottom of the package substrate 23, and are connected to other wiring substrates such as a printed board. Note that the solid-state image sensing element is not shown in FIGS. 4A to 4D.

The sidewall portion 22 serves as a spacer portion for separating a glass plate 2 (which will be described later) from the semiconductor chip 1′ so that the glass plate 2 does not contact the semiconductor chip 1′ and the bonding wires 31.

As shown in FIG. 4A, in the present embodiment, an adhesive sheet 10′ is attached to the top surface of the sidewall portion of the package substrate 23. The adhesive sheet 10′ is a lamination of a light-transmitting base film 11′ and an ultraviolet (UV) curable resin layer 12. The adhesive sheet 10′ is attached so that the UV curable resin layer 12 faces the package substrate 23. The UV curable resin layer 12 contacts only the top surface of the sidewall portion 22 of the package substrate 23.

The light-transmitting base film 11′ of the present embodiment is preferably a plastic film such as a polyester film and a polypropylene film.

A mask 25 is then placed on the adhesive sheet 10′ (on the base film 11′ of the adhesive sheet 10′). The mask 25 is present only on the sidewall portion 22 and shields only the part of the UV curable resin layer 12 which is in contact with the sidewall portion 22 from light 30. After the mask 25 is placed on the adhesive sheet 10′, light 30 containing UV rays is radiated to the adhesive sheet 10′ from the side of the base film 11′. Since the base film 11′ has a light-transmitting property, the light 30 reaches the UV curable resin layer 12 through the base film 11′ and cures the UV curable resin layer 12. The part of the UV curable resin layer 12 which is in contact with the sidewall portion 22 is not cured by the light 30 due to the light-shielding effect of the mask 25. The base film 11′ is capable of transmitting about 80% of light having a wavelength that cures the UV curable resin of the UV curable resin layer 12. Therefore, curing of the UV curable resin layer 12 can be conducted by merely radiating light to the adhesive sheet 10′ from the side of the base film 11′ for a short period of time.

The mask 25 is then removed as shown in FIG. 4B. The UV curable resin layer 12 is now formed from a cured UV curable resin layer 12A which has been exposed to the light and uncured UV curable resin 15.

As shown in FIG. 4C, the cured UV curable resin layer 12A is removed together with the base film 11′ from the package substrate 23. Since the cured UV curable resin layer 12A has adhered to the base film 11′, the cured UV curable resin layer 12A is easily removed together with the base film 11′ from the package substrate 23. As a result, the UV curable resin 15 remains only on the top surface of the sidewall portion 22. In other words, the UV curable resin 15 is applied only to the top surface of the sidewall portion 22.

As shown in FIG. 4D, the glass plate 2 is then bonded to the package substrate 23 by the UV curable resin 15. More specifically, the glass plate 2 is placed on the sidewall portion 22 so as to cover (cap) the recess of the package substrate 23 to seal the semiconductor chip 1′ in the recess. Bonding is then conducted by radiating light 30 to the UV curable resin 15 through the glass plate 2.

FIG. 4D shows the solid-state image sensing device with the glass plate thus produced by the present embodiment. The UV curable resin 15 is reliably applied only to the required part (in this example, the top surface of the sidewall portion 22) by simply placing the mask 25 on the adhesive sheet 10′ having the light-transmitting base film 11′ and radiating the light 30 to the adhesive sheet 10′. Since the UV curable resin 15 is present neither inside the recess of the package substrate 23 nor outside the package substrate 23, there is no adverse effect on the image and on the accuracy of the outer shape as in the first embodiment.

Like the first embodiment, the present embodiment uses an adhesive sheet. Therefore, application can be conducted by a simple process, and various kinds of adhesive can be used.

### Third Embodiment

Like the second embodiment, a photocurable-resin application method for bonding a glass plate to a package substrate having a semiconductor chip mounted thereon will be described in the third embodiment. The third embodiment is the same as the second embodiment except that the photocurable resin is applied to the glass plate instead of the package substrate. Therefore, only the difference between the second and third embodiments will be described below in detail.

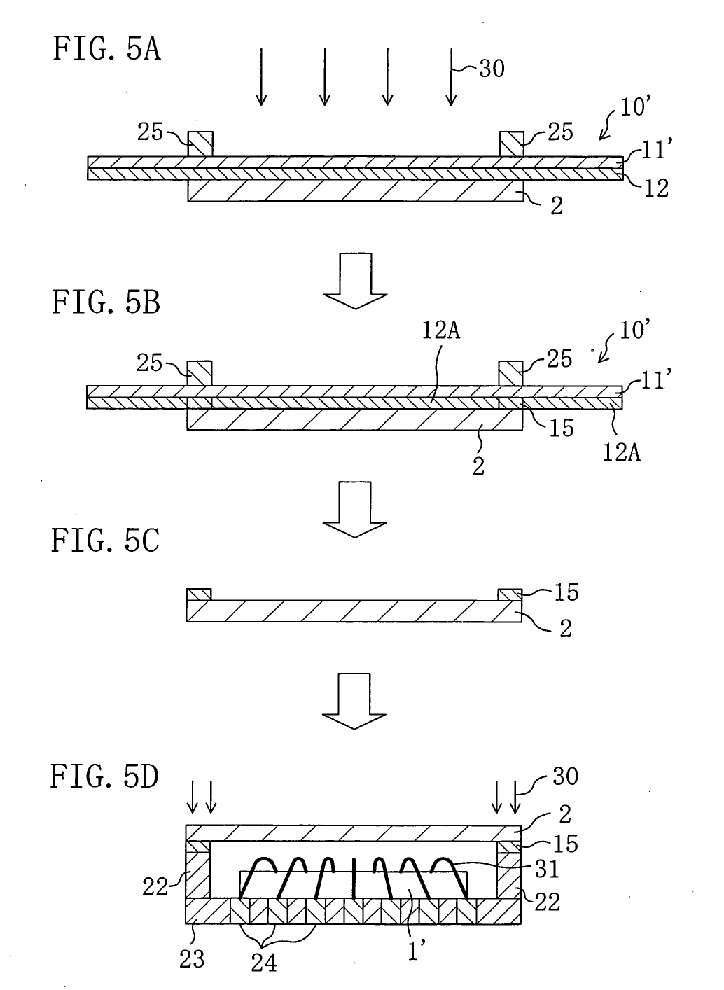

As shown in FIG. 5A, in the present embodiment, an adhesive sheet 10′ is first attached to a glass plate 2 so that an ultraviolet (UV) curable resin layer 12 contacts the glass plate 2.

A light-shielding mask 25 is then placed on the adhesive sheet 10′ (on a base film 11′ of the adhesive sheet 10′). The mask 25 has the same shape as that of the top surface of a sidewall portion 22 of a package substrate 23. In other words, the portion which is shielded from light by the mask 25 has the same shape as that of the top surface of the sidewall portion 22. In FIG. 5A, the mask 25 is placed along the outer periphery of the glass plate 2. In the present embodiment, the glass plate 2 has the same size and shape as those of the outer periphery of the top surface of the sidewall portion 22 of the package substrate 23.

After the mask 25 is placed on the adhesive sheet 10′, light 30 containing UV rays is radiated to the adhesive sheet 10′ from the side of the base film 11′. Since the base film 11′ is a light-transmitting film, the light 30 reaches a UV curable resin layer 12 through the base film 11′ and cures the UV curable resin layer 12. Note that since the part of the UV curable resin layer 12 which is located on the outer periphery of the glass plate 2 is shielded from the light by the mask 25, this part of the UV curable resin layer 12 is not cured by the light 30.

The mask 25 is then removed as shown in FIG. 5B. The UV curable resin layer 12 is now formed from a cured UV curable resin layer 12A which has been exposed to the light and uncured UV curable resin 15.

As shown in FIG. 5C, the cured UV curable resin layer 12A is removed together with the base film 11′ from the glass plate 2. The uncured UV curable resin 15 remains on the outer periphery of the glass plate 2. The uncured UV curable resin 15 is thus applied to the outer periphery of the glass plate 2. Note that since the position of the mask 25 is accurately controlled, the UV curable resin 15 will not be present outside the glass plate 2.

As shown in FIG. 5D, the glass plate 2 is then bonded to the package substrate 23 with the UV curable resin 15. The glass plate 2 shown in FIG. 5C is inverted, and then attached to the package substrate 23 so that the UV curable resin 15 faces the top surface of the sidewall portion 22. The glass plate 2 thus placed on the top surface of the sidewall portion 22 covers the recess of the package substrate 23 and seals a semiconductor chip 1′ in the recess. Light 30 is then radiated to the UV curable resin 15 through the glass plate 2 in order to bond the glass plate 2 to the package substrate 23.

The solid-state image sensing device with the glass plate thus produced by the present embodiment is the same as that of the second embodiment. The present embodiment has the same effects as those of the second embodiment.

### Fourth Embodiment

In the fourth embodiment, a photocurable-resin application method for bonding a glass plate directly to a semiconductor chip having a solid-state image sensing element formed thereon will be described. In the present embodiment, a photocurable resin is applied to a glass plate. Since the photocurable resin is applied by the same method as that of the third embodiment, description thereof will be omitted.

A semiconductor chip 1′ of the present embodiment has a solid-state image sensing element 5 formed on one surface. The solid-state image sensing element 5 is formed in the center of the surface of the semiconductor chip 1′. The semiconductor chip 1′ has an input/output (I/O) portion outside the solid-state image sensing element 5. The portion of the semiconductor chip 1′ which is located outside the I/O portion is used for bonding with the glass plate 2. In other words, the outer periphery of the surface of the semiconductor chip 1′ on which the solid-state image sensing element 5 is formed is a margin for bonding with the glass plate 2 (hereinafter, sometimes referred to as “bonding margin”). The semiconductor chip 1′ has a connection via 37 which extends from the surface on which the solid-state image sensing element 5 is formed to the opposite surface. The connection via 37 is electrically connected to the I/O portion. A connection terminal 38 protrudes outwards from the connection via 37. The connection terminal 38 is used for connection with a printed board and the like.

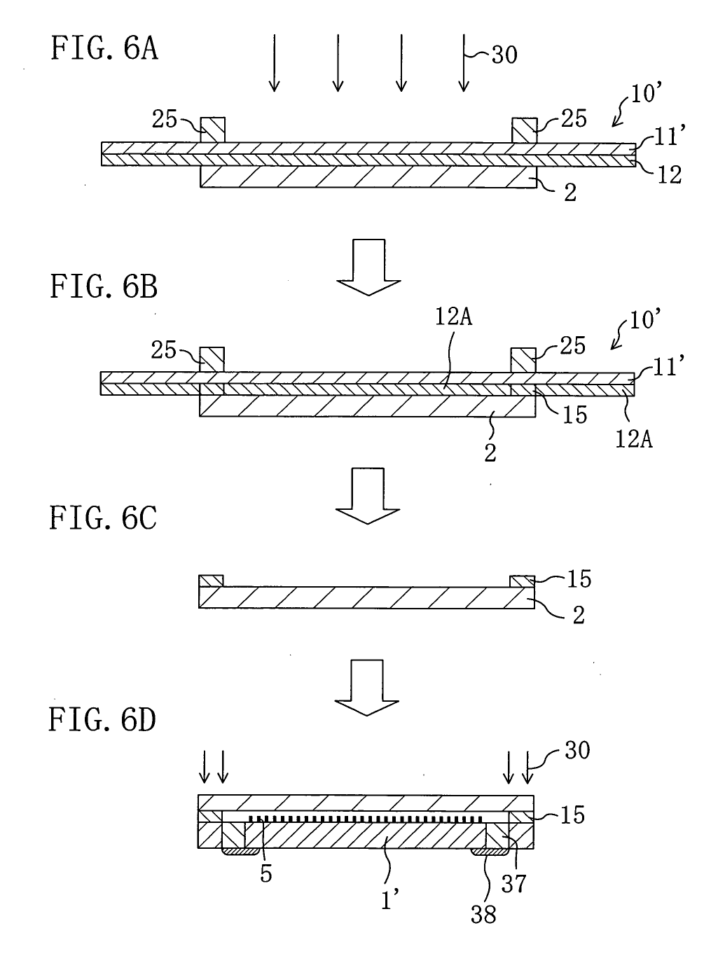

In the present embodiment, as in the third embodiment, an ultraviolet (UV) curable resin 15 is applied to a glass plate 2 as shown in FIGS. 6A to 6C, and the glass plate 2 is then attached to the semiconductor chip 1′ as shown in FIG. 6D. Thereafter, the UV curable resin 15 is cured by light 30, whereby the glass plate 2 is bonded to the semiconductor chip 1′. A mask 25 has the same shape as that of the bonding margin of the semiconductor chip 1′.

The solid-state image sensing device of the type shown in FIG. 6D is a semiconductor device called “wafer level sensor package.” The glass plate 2 faces the surface of the semiconductor chip 1′ on which the solid-state image sensing element 5 is formed. Since the glass plate 2 is separated from the surface of the semiconductor chip 1′by the thickness of the UV curable resin 15, the glass plate 2 does not contact the solid-state image sensing element 5.

In the present embodiment, the mask 25 can be accurately placed at the position corresponding to the portion of the glass plate 2 to which an adhesive is to be applied. Therefore, the UV curable resin 15 which is applied to bond the glass plate 2 to the semiconductor chip 1′ can be prevented from extending toward the solid-state image sensing element 5 and outside the semiconductor chip 1′. Therefore, there is no adverse effect on the image and on the accuracy of the outer shape.

The method for applying a UV curable resin and the method for bonding a glass plate have the same effects as those of the third embodiment.

### Fifth Embodiment

The fifth embodiment is the same as the third embodiment except that a spacer is provided on a glass plate 2. Therefore, only the difference between the fifth embodiment and the third embodiment will be described below.

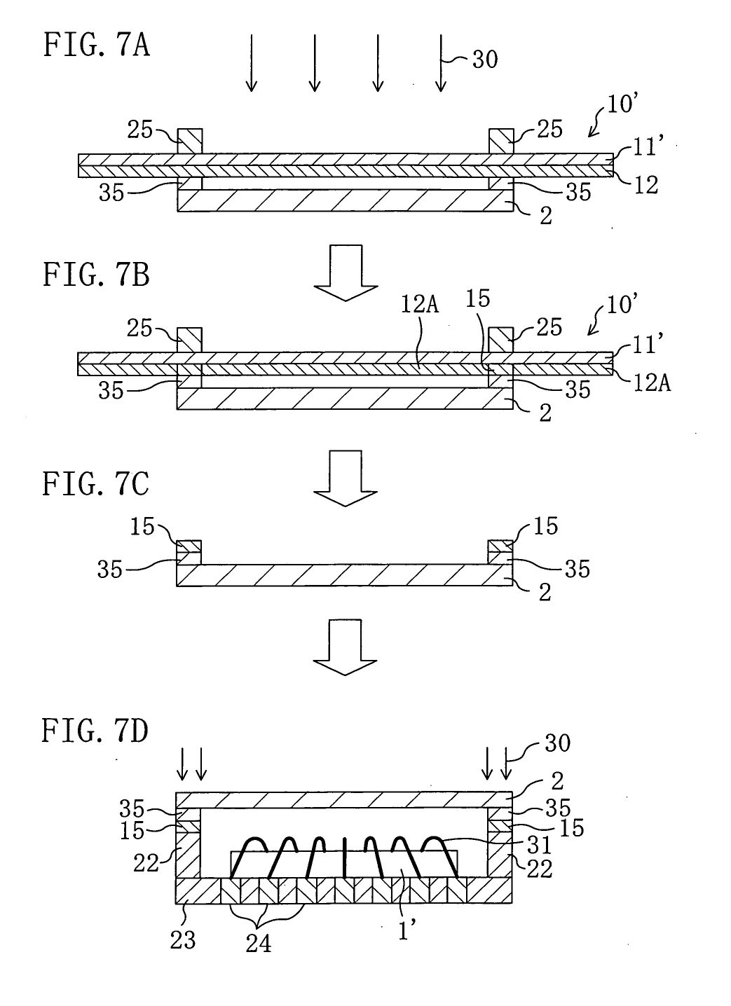

In the present embodiment, a spacer 35 is formed on the outer periphery of the glass plate 2 as shown in FIGS. 7A to 7D. The spacer 35 is formed at a position substantially corresponding to the top surface of a sidewall portion 22, and the surface of the spacer 35 faces the entire top surface of the sidewall portion 22 when the glass plate 2 is placed on a package substrate 23.

In order to apply an ultraviolet (UV) curable resin 15 to the glass plate 2, an adhesive sheet 10′ is first attached to the glass plate 2 as shown in FIG. 7A. Actually, a UV curable resin layer 12 adheres only to the top surface of the spacer 35. Due to the thickness of the spacer 35, the UV curable resin layer 12 does not adhere to the surface of the glass plate 2. The UV curable resin layer 12 may adhere to the surface of the glass plate 2 due to sagging or the like. However, this does not cause any problem because the UV curable resin layer 12 that adheres to the surface of the glass plate 2 is cured by light in a later step. Note that the bottom surface of the spacer 35 is the surface that is in contact with the glass plate 2 and the top surface of the spacer 35 is the opposite surface.

A mask 25 is then placed on a base film 11′ of the adhesive sheet 10′ so as to face the spacer 35. The mask 25 has approximately the same size as, or smaller than, that of the spacer 35. Light 30 is then radiated to the UV curable resin layer 12 through the base film 11′. As a result, the UV curable resin layer 12 is cured except the portion which is shielded by the mask 25. The cured UV curable resin layer 12A is thus formed as shown in FIG. 7B.

As shown in FIG. 7C, the mask 25 is then removed, and the cured UV curable resin layer 12A is removed together with the base film 11′ from the glass plate 2.

As shown in FIG. 7D, the glass plate 2 is inverted, and then attached to the package substrate 23 so that the UV curable resin 15 is placed on the top surface of the sidewall portion 22 of the package substrate 23. Thereafter, the glass plate 2 is bonded to the package substrate 23 by radiation of light 30.

The solid-state image sensing device with the glass plate thus produced according to the present embodiment is the same as the solid-state image sensing device with the glass plate according to the second and third embodiments except that the spacer 35 is provided between the glass plate 2 and the UV curable resin 15. The UV-curable resin application method and the bonding method of the present embodiment have the same effects as those of the third embodiment. In the present embodiment, the spacer 35 reliably prevents the glass plate 2 from contacting the solid-state image sensing element and the bonding wires 31.

### Sixth Embodiment

The sixth embodiment is the same as the fourth embodiment except that a spacer is provided on the glass plate 2. Therefore, only the difference between the sixth embodiment and the fourth embodiment will be described below.

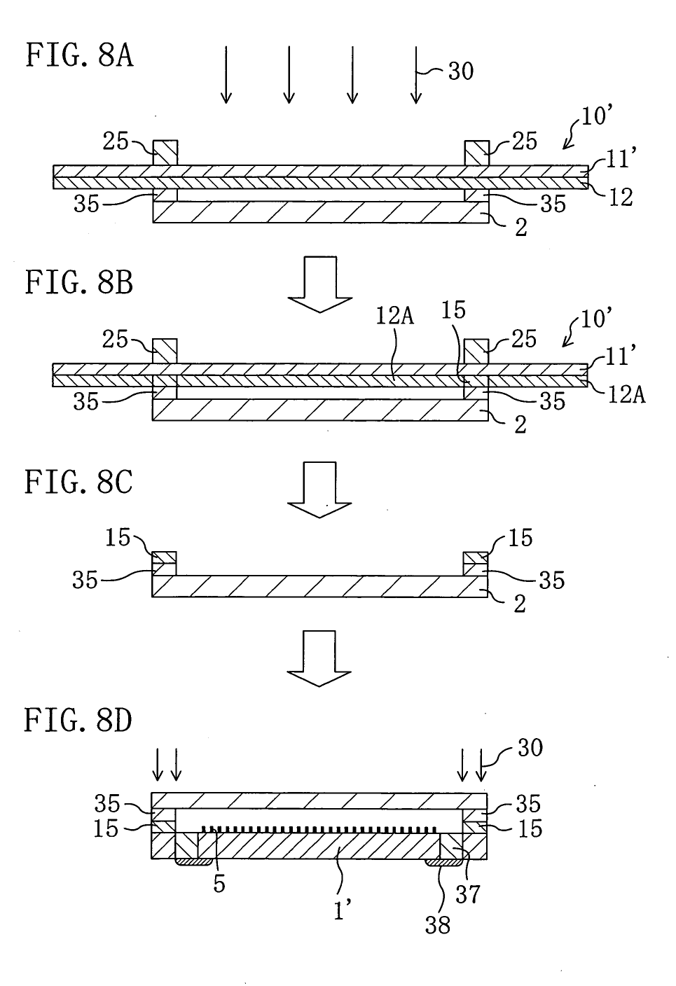

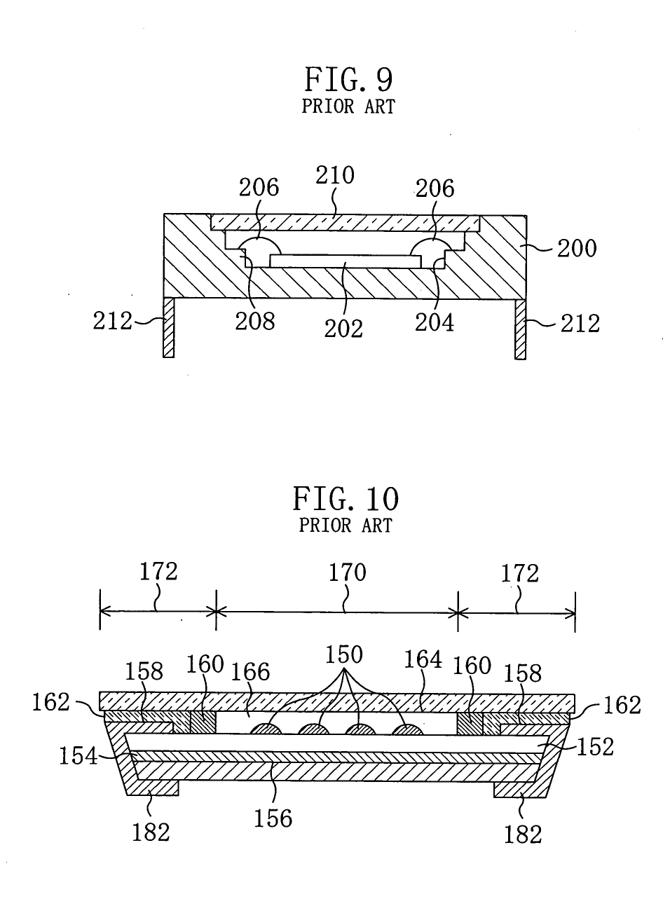

As shown in FIGS. 8A to 8D, in the present embodiment, a spacer 35 is provided on the outer periphery of the glass plate 2. The glass plate 2 of the present embodiment has the same shape as that of the glass plate 2 of the fifth embodiment. The outer periphery of a semiconductor chip 1′ serves as a bonding margin (a margin for bonding with the glass plate 2). The spacer 35 of the present embodiment is formed at a position corresponding to the bonding margin of the semiconductor chip 1′ and has a shape corresponding to the shape of the bonding margin. In other words, the spacer 35 exactly overlaps the bonding margin of the semiconductor chip 1′ when the glass plate 2 is attached to the semiconductor chip 1′.

A method for applying an UV curable resin 15 to the glass plate 2 is the same as the application method of the fifth embodiment. Therefore, description thereof will be omitted.

A method for bonding the glass plate 2 to the semiconductor chip 1′ is the same as the bonding method of the fourth embodiment. Therefore, description thereof will be omitted.

The solid-state image sensing device with the glass plate according to the present embodiment is the same as the solid-state image sensing device with the glass plate according to the fourth embodiment except that the spacer 35 is provided between the glass plate 2 and the UV curable resin 15. The UV-curable resin application method and the bonding method according to the present embodiment have the same effects as those of the fourth embodiment. In the present embodiment, the spacer 25 reliably prevents the glass plate 2 from contacting the solid-state image sensing element 5.

### Other Embodiments

A semiconductor chip having a solid-state image sensing element formed thereon is used in the first to sixth embodiments. However, a semiconductor chip having other kinds of light-receiving element formed thereon or a semiconductor chip having a light-emitting element such as laser formed thereon may be used because the optical element portion of these semiconductor chips needs to be protected by a light-transmitting plate such as a glass plate.

In order to bond the glass plate 2 to the package substrate 4, 23 or the semiconductor chip 1′ by using the UV curable resin 15, the UV curable resin 15 may be cured by heat instead of light.

An example of the UV curable resin 15 of the UV curable resin layer 12 is photosensitive polyimide. However, the present invention is not limited to this. A resin that is curable by electron beams or the like may be used instead of the UV curable resin 15.

In the second to sixth embodiments, the UV curable resin 15 is preferably applied to a plurality of application target members (package substrates 23 or glass plates 2) at a time. In this case, it is preferable to use a single adhesive sheet for the plurality of application target members which are arranged next to each other. However, a plurality of adhesive sheets may be used.

The application target member for the photocurable resin is not limited to a glass plate, a package substrate, and a semiconductor chip. The application target member is preferably a thing which requires accurate control of the application position and range of the photocurable resin, such as a printed board and machine parts. However, the application target member may be anything as long as the photocurable resin needs to be applied thereto.

For example, in the solid-state image sensing device of FIG. 3, the photocurable resin may be used as the resin 6 for sealing the connection between the semiconductor chip 1 and the package substrate 4. In other words, the photocurable resin may be applied to the sealing portion as an application target member. In this case, the photocurable resin may be applied by the following method: the adhesive sheet 10 is first attached to the package substrate 4. The photocurable resin is then applied only to the sealing portion of the package substrate 4 by using a mask. Thereafter, the semiconductor chip 1 is connected to the package substrate 4 and the photocurable resin is cured. Alternatively, the photocurable resin may be applied by the following method: the adhesive sheet 10 is first attached to the semiconductor chip 1. The photocurable resin is then applied to the sealing portion of the semiconductor chip 1 by using a mask. Thereafter, the semiconductor chip 1 is connected to the package substrate 4 and the photocurable resin is cured. Alternatively, the photocurable resin may be applied by the following method: the semiconductor chip 1 is first connected to the package substrate 4. Thereafter, the photocurable resin is applied to the sealing portion by using the adhesive sheet 10, and the applied photocurable resin is cured. In the case where the photocurable resin is applied after the semiconductor chip 1 is connected to the package substrate 4, it is preferable that the adhesive sheet 10 is flexible enough to be attached along the thickness of the semiconductor chip 1.

The application method of the present invention may be used to fix the semiconductor chip 1′ to the package substrate 23 of the second, third, and fifth embodiments by using the photocurable resin as an adhesive. The method of the present invention may be used to bond a substrate other than the substrate of these embodiments with a semiconductor element. The method of the present invention may be used to apply a photocurable resin as an underfill in flip-chip bonding.

A mask may be used when light is radiated to an application target member having a through hole like the package substrate of the first embodiment. In all embodiments, a light-transmitting plate such as a plastic plate may be used instead of the glass plate.

In the present invention, a sheet formed as a lamination of a base film and a photocurable resin layer is attached to an application target member, and light is radiated only to a required part of the photocurable resin so that the remaining part of the photocurable resin remains uncured. The cured photocurable resin is then removed together with the base film from the application target member. The application position and range of the photocurable resin can be accurately controlled in the present invention.

What is claimed is:

1. A method for applying a photocurable resin, comprising the steps of:
(A) attaching a sheet that is formed from a lamination of a base film and a photocurable resin layer to an application target member so that the photocurable resin layer contacts the application target member;
(B) curing a part of the photocurable resin layer by radiating light to the part of the photocurable resin layer; and
removing the cured part of the photocurable resin layer together with the base film from the application target member.

2. The method according to claim 1, wherein
the application target member has a through hole, and
in the step (B), the part of the photocurable resin layer is cured by light passing through the through hole.

3. The method according to claim 1, wherein
the base film has a light-transmitting property, and
in the step (B), a light-shielding mask is formed on a part of the base film and the light is radiated to the part of the photocurable resin layer through the base film.

4. The method according to claim 1, wherein
a plurality of application target members are provided, and
in the step (A), at least one sheet is attached to the plurality of application target members.

5. The method according to claim 1, wherein the photocurable resin is an ultraviolet (UV) curable resin.

6. A method for bonding a light-transmitting plate to a wiring substrate, wherein the wiring substrate has a through hole, and the light-transmitting plate is bonded to the wiring substrate so as to cover the through hole, the method comprising the steps of:
applying a photocurable resin to the wiring substrate, an application target member, by using a method for applying a photocurable resin, the method for applying the photocurable resin including the steps of (A) attaching a sheet that is formed from a lamination of a base film and a photocurable resin layer to an application target member so that the photocurable resin layer contacts the application target member, (B) curing a part of the photocurable resin layer by radiating light to the part of the photocurable resin layer, and removing the cured part of the photocurable resin layer together with the base film from the application target member; and
bonding the light-transmitting plate to the wiring substrate by using the applied photocurable resin.

7. A method for bonding a light-transmitting plate to a wiring substrate, wherein the wiring substrate has an optical element chip mounted thereon, the optical element chip has an optical element formed on one surface, and the light-transmitting plate is bonded to the wiring substrate so as to face the surface on which the optical element is formed, the method comprising the steps of:
applying a photocurable resin to the wiring substrate, an application target member, by using a method for applying a photocurable resin, the method for applying the photocurable resin including the steps of (A) attaching a sheet that is formed from a lamination of a base film and a photocurable resin layer to an application target member so that the photocurable resin layer contacts the application target member, (B) curing a part of the photocurable resin layer by radiating light to the part of the photocurable resin layer, and removing the cured part of the photocurable resin layer together with the base film from the application target member; and
bonding the light-transmitting plate to the wiring substrate by using the applied photocurable resin.

8. The method according to claim 7, wherein
a spacer portion is provided on the wring substrate in order to prevent the optical element from contacting the light-transmitting plate, and
the light-transmitting plate is bonded to the spacer portion.

9. A method for bonding a light-transmitting plate to a wiring substrate, wherein the wiring substrate has an optical element chip mounted thereon, the optical element chip has an optical element formed on one surface, and the light-transmitting plate is bonded to the wiring substrate so as to face the surface on which the optical element is formed, the method comprising the steps of:
applying a photocurable resin to the light-transmitting plate, an application target member, by using a method for applying a photocurable resin, the method for applying the photocurable resin including the steps of (A) attaching a sheet that is formed from a lamination of a base film and a photocurable resin layer to an application target member so that the photocurable resin layer contacts the application target member, (B) curing a part of the photocurable resin layer by radiating light to the part of the photocurable resin layer, and removing the cured part of the photocurable resin layer together with the base film from the application target member; and
bonding the light-transmitting plate to the wiring substrate by using the applied photocurable resin.

10. A method for bonding a light-transmitting plate to an optical element chip, wherein the optical element chip has an optical element formed on one surface, and the light-transmitting plate is bonded to the optical element chip so as to face the surface on which the optical element is formed, the method comprising the steps of:
applying a photocurable resin to the light-transmitting plate, an application target member, by using a method for applying a photocurable resin, the method for applying the photocurable resin including the steps of (A) attaching a sheet that is formed from a lamination of a base film and a photocurable resin layer to an application target member so that the photocurable resin layer contacts the application target member, (B) curing a part of the photocurable resin layer by radiating light to the part of the photocurable resin layer, and removing the cured part of the photocurable resin layer together with the base film from the application target member; and
bonding the light-transmitting plate to the optical element chip by using the applied photocurable resin.

11. The method according to claim 9, wherein
a spacer portion is provided on the light-transmitting plate in order to prevent the optical element from contacting the light-transmitting plate, and
the photocurable resin is applied to the spacer portion.

12. The method according to claim 10, wherein
a spacer portion is provided on the light-transmitting plate in order to prevent the optical element from contacting the light-transmitting plate, and
the photocurable resin is applied to the spacer portion.
